(19) United States
(12) Patent Application Publication
(10) Pub. No.: US 2006/0120361 A1
(43) Pub. Date: Jun. 8, 2006

(54) Method and system for providing packet data services

(75) Inventors: Abhishek Sharma, Streamwood, IL (US); Arun Alex, Bartlett, IL (US); Sudhir Kunnath, Bolingbrook, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom, Inc., Alameda, CA (US)

(21) Appl. No.: 11/003,831

(22) Filed: Dec. 3, 2004

(51) Int. Cl. H04L 12/50

(52) U.S. Cl. 370/386

(57) ABSTRACT

A platform for processing data packets included in a flow of packet data traffic that is being communicated in a data network is disclosed. The platform includes a backplane for routing the data packets within the platform. The platform also includes a packet switch card coupled with the backplane. The packet switch card aggregates the flow of packet data traffic in the platform. The platform further includes a plurality of application cards coupled with the backplane, each of the application cards of the plurality selectively operating as at least one of a network interface card and a network access card. At least one application card of the plurality of application cards operates as a network interface card, the first application card communicating at least a portion of the flow of packet data traffic from the network to the packet switch card.

### CROSS REFERENCE TO RELATED APPLICATIONS

This application is related to commonly assigned, co-pending U.S. patent applications Ser. No. ______, filed on ______ and entitled “Method and System for Decryption of Encrypted Packets” and Ser. No. ______, filed on ______ and entitled “Method and System for Load Balancing in Network Platform”, both to the same inventors as the instant application. The disclosures of U.S. patent application Ser. Nos. ______ and ______ are incorporated herein by reference in their entirety.

### BACKGROUND

I. Field

This invention is related to data communications and, more specifically, to systems and methods for processing data packets in a data network.

II. Description of Related Art

The use of technology for accessing the Internet, the World Wide Web and/or other types of packet data networks (e.g., business or private networks) continues to increase at a rapid rate. The advent of wireless mobile devices, such as wireless phones, wireless personal digital assistants (PDAs) and wireless network enabled notebook computers, provides users of such devices with the ability to access data networks from any location where radio coverage facilitating such access is available. Such access may be provided using protocols such as the Mobile Internet Protocol (Mobile IP). Mobile IP functions may be implemented in accordance with the Code Division Multiple Access (CDMA) 2000 standard, which is described in further detail in the Telecommunications Industry Association (“TIA”) standards IS-95A and IS-95B, which are both incorporated herein by reference in their entirety. CDMA is also described in the International Telecommunications Union (“ITU”) IMT-2000 series of standards, which are all incorporated herein by reference in their entirety. CDMA is further described in the TIA IS-2000 series of standards, which are all incorporated herein by reference in their entirety. The IS-2000 series of standards are commonly referred to as CDMA2000.

The rapid growth in the use of such techniques for accessing data networks has motivated the development of network systems that provide such data services with ever-increasing bandwidth. Additionally, rising infrastructure and operating costs associated with implementing and maintaining such networks (e.g., Mobile IP networks) has motivated the development of network devices and systems/platforms that may be employed in multiple applications and/or provide multiple functions concurrently. For example, the same network platform may provide both packet data serving node (PDSN) functions and/or home agent (HA) functions in a Mobile IP network. PDSN and HA services are described in detail in the CDMA2000 standards and will not be described in detail here.

One such platform that has been used for providing network data services is a so-called mid-plane based platform. In a mid-plane based approach, a plurality of network interface cards (NICs), which may also be termed line cards are coupled with a mid-plane. Each NIC is then coupled with one or more network access cards (NACs), which may also be termed application cards, via the mid-plane. In such a system, the NICs provide connectivity to the data network and the NACs perform network services on data packets communicated to the system (e.g., PDSN or HA services).

Such mid-plane systems also typically include a low-speed signaling bus that is used for system management. This bus may be termed a system management bus or a system control bus and these terms are used interchangeably in this disclosure. In such an approach, the individual network devices (e.g., corresponding combinations of NICs and NACs) in a single platform operate substantially independently of one another, with minimal or no interaction between them.

In such implementations, each NIC and NAC combination effectively operates as a stand-alone device. Therefore, such an approach typically uses one network address and one network cable per NIC and NAC combination. The use of substantially stand-alone NIC and NAC combinations operating in parallel is a way of increasing the overall available data bandwidth in and out of a network platform.

Mid-plane approaches, however, have certain disadvantages. For example, because each NIC and NAC combination in the platform operates substantially independently, each NIC and NAC combination is assigned an individual address (an IP address in this example) and is connected to an individual network cable. Therefore, in such a system, there are a large number of points of failure, which may decrease the reliability of such systems. Further, if one of the devices (e.g., a NIC or a NAC) in a mid-plane system fails, all data traffic being sent to the IP address associated with the failed device will potentially be lost. Such an approach also does not take full advantage of the increases in data bandwidth that are now available on a single network connection.

In addition, because each NIC and NAC combination in a mid-plane system operates on an individual IP address, the types of network data services must predetermined for each combination. For example, if a specific IP address is designated to provide PDSN services, a NIC and NAC combination operating with that IP address must provide PDSN services or the network will not function properly. Thus, the NIC and NAC combination typically cannot be used to provide other functions (e.g. HA functions) without removing the network platform from service and reconfiguring the type of service each NIC and NAC combination provides. Therefore, hardware redundancy in such a mid-plane system is not readily implemented.

### SUMMARY

Methods and systems for processing data packets in a data network are disclosed. An exemplary method includes processing data packets in a distributed fashion.

The exemplary method includes receiving a data packet at a packet switch device or card that is included in a network platform/system. The packet switch card may receive the data packet directly (e.g., via a network interface included in the packet switch device). Alternatively, a first packet-processing card (operating as a line card) that is included in the network platform may receive the data packet. In this situation, the first packet-processing device then communicates the data packet to the packet switch device. The packet-processing device (or card) may also be termed a wireless application card, and these terms are used interchangeably throughout this disclosure. Such packet-processing devices may be implemented using a combination of hardware, software and/or firmware, or using any other appropriate approach. In an exemplary network platform for providing PDSN and/or HA services, a plurality of packet-processing cards are included and are coupled with the packet switch card via a high-speed backplane.

After receiving the data packet, the packet-switch card determines a second packet-processing device (assuming the data packet is received by a first packet-processing device) in the network platform for processing the data packet. This determination is made based on the type of packet that is received. For example, if the received packet is an encrypted packet, the packet switch may perform a hash function on a predetermined number of bits of a header of the encrypted data packet and determine the second packet-processing device based on the result of the hash function (e.g., by referencing a look up table). Alternatively, for encrypted packets, this determination could be made based on a predetermined field of bits in the encrypted data packet header.

If the packet is a clear data packet (unencrypted), the packet switch examines the headers of the packet to determine which packet-processing card is responsible for processing the packet. This may be determined by a communication session identifier (e.g., the IP address of the device that originally sent the packet) included in the packet's headers.

The method then includes communicating the data packet from the packet switch card to the second packet-processing device and processing the data packet with the second packet-processing device. For an encrypted packet, the processing includes decrypting the packet, while for clear data packets, the processing includes performing network services (e.g., PDSN or HA services) on the packet. The second-packet processing device then communicates the processed packet back to the packet switch card. It will be appreciated that other types of network services may also be provided. For example, the network services may comprise virtual private networking (VPN) services, as an example.

After the packet switch card receives the processed data packet, further processing of the packet may be done in a similar fashion as described above. For example, if the packet was originally encrypted (and a clear data packet was returned to the packet switch), the packet switch may determine a third packet-processing device for performing network services on the clear data packet. Alternatively, the packet switch may determine a packet-processing device for encrypting a processed packet (e.g., a packet on which network services have been performed). The packet switch would then communicate the data packet to the appropriate packet-processing device for further processing.

Once all processing of the packet is completed in the network platform, the packet, in its final form (e.g., encrypted or unencrypted), is communicated to the packet switch. The packet switch then communicates the packet to its next destination (as indicated in the packet's headers) via its network interface or via one of the packet-processing cards, such as the packet-processing card that received the packet initially.

It will be appreciated that any number of approaches are possible for communicating the data packets within the network platform. For example, the data packets may be communicated between the packet switch card and the packet-processing card using the Multi Protocol Label Switching (MPLS) protocol. In such an approach, an MPLS header is included with each packet when it is communicated within the network platform. The MPLS protocol is described in further detail in the Internet Engineering Task Force's (IETF's) Request for Comments (RFC) 3031, which is incorporated by reference herein in its entirety. Of course, numerous other techniques for communicating packets within the network platform also exist. For example, User Datagram Protocol (UDP) headers could be used. As another alternative, encapsulation techniques such as Generic Route Encapsulation (GRE) or IP-in-IP could be used for communication within the network platform. Such techniques are known and will not be discussed in detail here.

A network platform/system for implementing the exemplary method described above (and other methods for processing data packets and providing network services) includes a plurality of packet-processing cards. At least one packet-processing card of the plurality includes a decryptor for processing (decrypting) encrypted packets. Such a decryptor may be implemented as a hardware device implemented, in software and/or using firmware. Alternatively, the decryptor may be implemented using any other appropriate technique.

The network platform also includes a packet switch card. The packet switch card is operationally coupled with the plurality of packet-processing cards via a high-speed backplane. The packet switch card and the packet-processing cards communicate data packets between them via the high-speed backplane, such as in accordance with the MPLS protocol. The packet switch card and the packet-processing cards each include a programmable controller. These controllers include instructions that, when executed, collectively provide for implementing the method described above (or any other suitable method for providing network services).

These and other aspects will become apparent to those of ordinary skill in the art by reading the following detailed description, with reference, where appropriate, to the accompanying drawings. Further, it is to be understood that the embodiments noted in this summary are only examples and not intended to limit the scope of the invention as claimed.

### BRIEF DESCRIPTION OF THE DRAWINGS

Exemplary embodiments of the present invention are described herein with reference to the drawings, in which:

FIG. 1 is a diagram of a communication network that may employ the systems and methods shown in FIGS. 2-6;

FIGS. 2A and 2B are two diagrams illustrating a backplane-based network platform for providing packet data serving node and/or home agent services in a Mobile IP network;

FIG. 3 is a block diagram of a packet-processing card (e.g., wireless application card) of the platform shown in FIGS. 2A and 2B;

FIG. 4 is a block diagram of a packet switch card of the platform shown in FIGS. 2A and 2B;

FIGS. 5A-5D are diagrams illustrating data packets at various stages of processing with the platform of FIGS. 2A and 2B; and

FIG. 6 is a flowchart illustrating a method for providing network data services that may be implemented by the platform of FIGS. 2A and 2B.

### DETAILED DESCRIPTION

Embodiments of network platforms and methods for providing network data services are discussed generally in the context of wireless communication systems and packet data networks. However, it will be appreciated that the invention is not limited in this respect and that embodiments of the invention may be implemented in any number of types of communication systems, such as wired local area networks, and wired wide area networks, among any other type of appropriate data and/or communication network. As in most telecommunication and data applications, it will also be appreciated that many of the elements of the various embodiments described herein are functional entities that may be implemented as hardware, firmware and/or software or using any other appropriate technique. Additionally, many of the elements described in this disclosure may be implemented as discrete components or in conjunction with other components, in any suitable combination and location.

Organization of the Disclosure

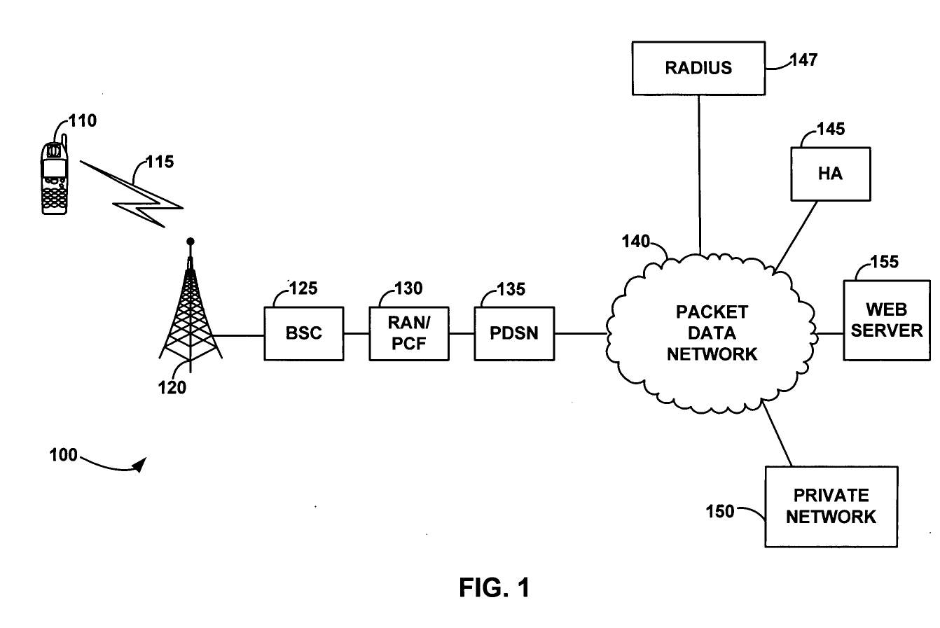

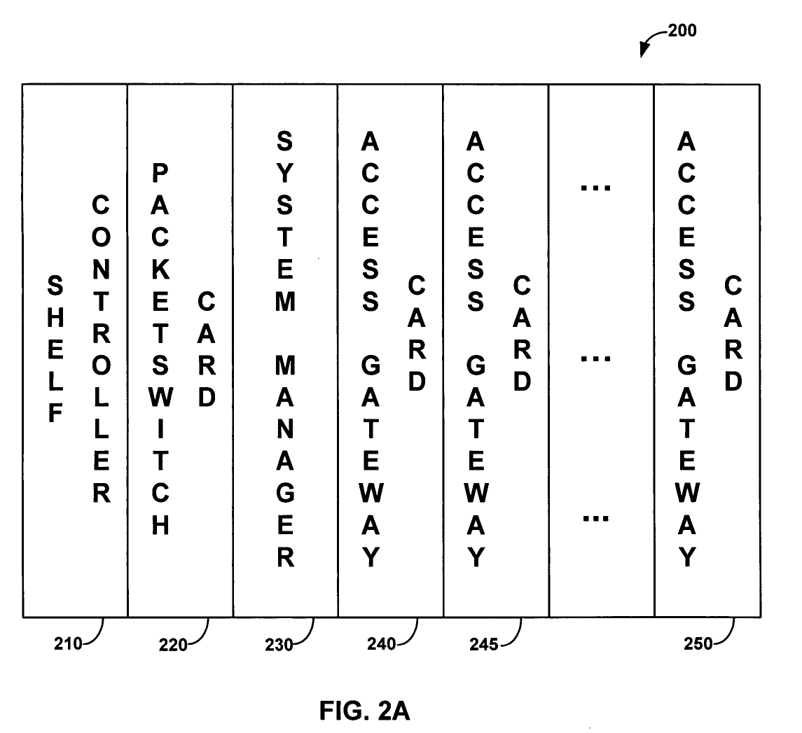

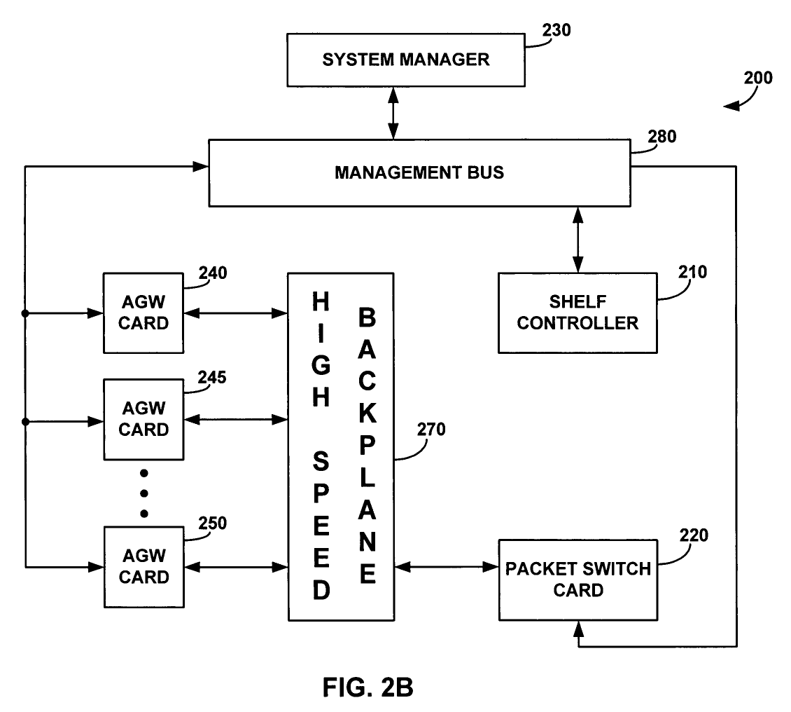

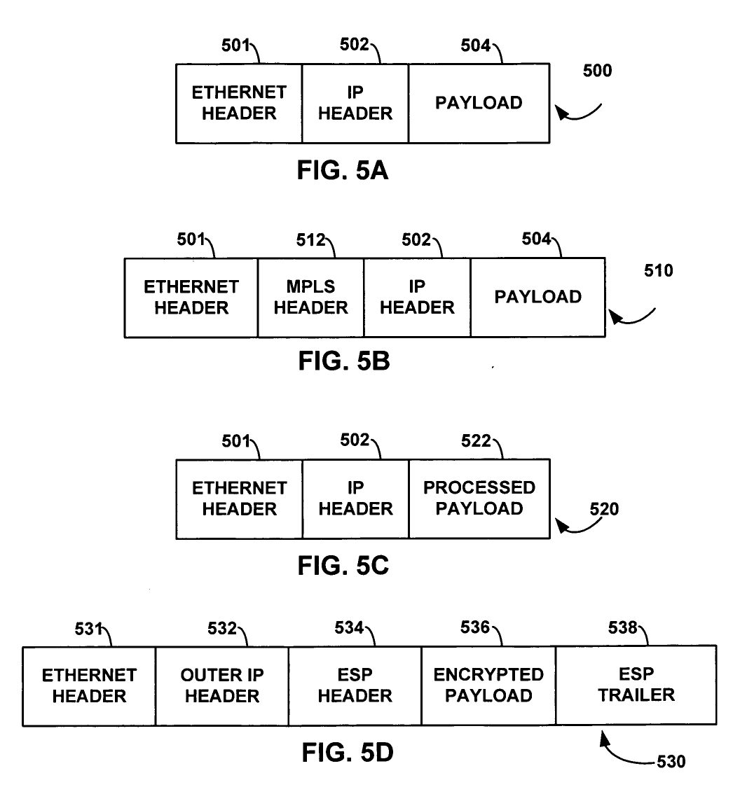

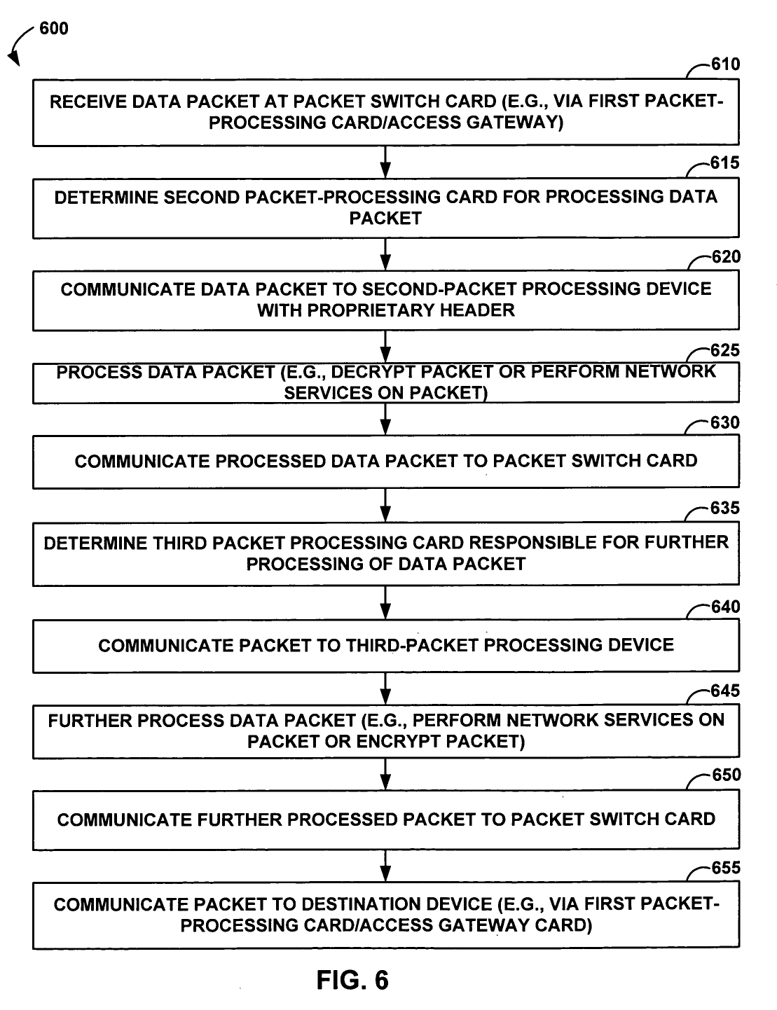

This disclosure is organized as follows. First, a data network in which a backplane-based network platform for providing various network services may be employed is described with reference to FIG. 1. The network of FIG. 1 includes a wireless data network that implements the Mobile IP protocol in accordance with the CDMA2000 standard. Second, a backplane-based network platform is described with reference to FIGS. 2-4. The network platform may be used in the system of FIG. 1 to provide, for example, packet data serving node and/or home agent services in the data network. Third, various data packet configurations are described with reference to FIGS. 5A-5C. The packet data configurations shown in FIGS. 5A-5D represent a single data packet at different stages of processing by the system shown in FIGS. 2A and 2B. Fourth, an exemplary method of processing a data packet, such as in the network platform of FIGS. 2A and 2B, is described with reference to FIG. 6.

Data Communications Network

FIG. 1 shows a data communication network 100 that is used for packet data communication. In network 100, a mobile station 110 is a wireless device, such as a wireless phone, a wireless personal digital assistant (PDA), a wireless enabled computer, or any other appropriate device that may be used in conjunction with a wireless communication network for data communications.

The mobile station 110 communicates with a radio network over an air interface 115. The radio network includes a base transceiver station (BTS) 120 that directly communicates with the client station 110 over the air interface 115 using radio frequency signals. The mobile station 110 may communicate with the BTS 120 using a variety of different protocols. For example, such communication may be accomplished using the CDMA2000 standard. Other wireless protocols may also be used. For example, the mobile station 110 and the BTS 120 may communicate using Wideband CDMA (WCDMA), Time Division-Synchronous CDMA (TD-SCDMA), Advanced Mobile Phone Service (AMPS), Digital AMPS (D-AMPS), Universal Mobile Telecommunications System (UMTS), Global System for Mobile Communication (GSM), IS-136, Time Division Multiple Access (TDMA), IEEE 802.11, Bluetooth (e.g., 802.15.1), MMDS, DECT, integrated digital enhanced network (IDEN), general packet radio service (GPRS) or other protocols.

The BTS 120 is coupled with a base station controller (BSC) 125. The BSC 125 is further coupled with a Radio Access Network/Packet Control Function Device 130, which in turn is coupled with a packet-data-serving node (PDSN) 135. The PDSN 135 then connects to a packet data network 140, such as the public Internet. These components and their operation are all described in further detail in the CDMA standards and will not be described in detail here for the purpose of brevity and clarity.

Using this connectivity, the mobile station 110 is then able to communicate with devices on the packet data network 140, as well as devices coupled with the packet network 140, such as a home agent 145, a Web server 155 and a private network 150, as some examples. The Web server 155, for example, provides the mobile station 110 access to the World Wide Web.

The data network of FIG. 1 also includes a Remote Authentication Dial-In User Service (RADIUS) sever 147 that is coupled with the packet network 140. As is known, the RADIUS server 147 (e.g., in cooperation with the PDSN 135 or the HA 145) authenticates users, authorizes access to private networks and collects information for the purposes of accounting and billing (such as user access time and charges). RADIUS servers and their role in data networks implementing the Mobile IP and CDMA standards are described in more detail in the TIA IS-835-C standard.

Data communications in the data network 100 may be accomplished using secure or unsecure communication sessions. When data communication is accomplished using a secure communication session, data packets are sent in encrypted format. For example, data packets sent as part of a secure communication session may be encrypted in accordance with the Internet Protocol Security (IPSEC) Protocol. The IPSEC Protocol is described in further detail in the IETF's Requests for Comments (RFCs) 2401, 2402 and 2406, which are incorporated by reference herein in their entirety. Of course, other encryption protocols may be used. Such protocols include Data Encryption Standard (DES) and Triple DES (3DES). However, for purposes of this disclosure, secure communication sessions will be described in the context of the IPSEC Protocol.

Both encrypted and clear data packets are communicated in the network 100 in accordance with the IP standard, the Ethernet standard (IEEE 802.3), the Mobile IP standard, and/or any other appropriate standard for data packet communications. Network services are provided by the various platforms of the network 100, such as the PDSN 135, the HA 145 and the Web Server 155, for example. However, for purposes of this disclosure, network platforms and methods for providing network services will be discussed generally in the context of the PDSN 135 and the HA 145. Of course, other types of network services, such as VPN services, may be provided in similar fashion as the embodiments disclosed here.

Backplane-Based Network Platform

FIGS. 2-4 illustrate a backplane-based network platform 200 that is used to provide PDSN and/or HA services in a Mobile IP compliant data communication network, such as the network 100 shown in FIG. 1. The platform 200 may be used to implement the PDSN 135 of FIG. 1 and/or the HA 145 of FIG. 1. Due to its backplane-based design, the platform 200 is able to provide both PDSN and HA services simultaneously. In such an application, PDSN services are provided using a first IP address while HA services are provided using a second IP address.

1. Overview

A backplane-based network platform may overcome at least some of the shortcomings of prior network platforms, such as mid-plane designs. For example, while mid-plane based designs include a relatively low-speed backplane between the individual NIC and NAC combinations in the platform, that low-speed backplane is only used for system configuration and/or management. In such systems, packet data is not communicated from one network device to another in the platform. Thus, each network device (e.g., network interface card or network access card) operates with a unique IP address and a separate network cable, which, as discussed above, is undesirable.

In contrast, backplane-based systems/platforms typically include a high-speed backplane for communicating packet data from one packet-processing card to another in the same platform. One such network device is the Total Control 2000 (TC2K) available from UTStarcom, Inc., 1275 Harbor Bay Parkway, Alameda, Calif. 94502. The backplane-based design allows for all packet data traffic in the TC2K system to be aggregated onto a single IP address.

Specifically, the TC2K backplane-based system includes multiple wireless application cards (packet-processing cards) coupled, via a high speed-backplane, with a packet switch card. The packet switch card performs packet routing and forwarding functions in the TC2K system. Because the packet switch card is capable of routing packets to the individual wireless applications cards, the TC2K system is able to aggregate all of the data traffic for the system onto a single network address (e.g., an IP address in this example) or a reduced number of IP addresses, depending on the particular implementation. Therefore, all of the application cards in the TC2K system may operate using the same IP address, or a number of IP addresses that is less than the total number of wireless application cards in the system. The packet switch routes packets to individual wireless application cards for processing based on the content of each packet.

For example, the packets may be routed based on a communication session identifier (e.g., the source IP address of the packet) that is included in the header of each packet. After determining the communication session identifier from the packet, the packet switch determines the wireless application card responsible for processing packets associated with that specific communication session. The packet switch comparing the communication system identifier from the packet to a table associating communication session identifiers and wireless application cards can make this determination, for example.

Furthermore, improvements in data networking hardware (e.g., routers, servers, etc.) have lead to corresponding increases in the data bandwidth that is available over a single network connection. Network speeds of 1 gigabit per second on a single cable (1 gigabit=1×10⁹ bits) are currently readily available, with network speeds of 10 gigabits per second also becoming more readily available. Such increases in the data bandwidth available on a single network connection allow systems (such as the TC2K) implementing a single-IP address (or fewer IP addresses than the total number of application cards in the system) to employ a single network cable per IP address that have even greater data bandwidth than previous mid-plane systems. However, it may be desirable to employ two network cables per IP address for hardware redundancy and increased system reliability. For example, if an application card that is operating as a NIC for the provision of PDSN services were to fail, the second application card connected with the redundant network cable could be activated in its place, thus preventing a loss of network services.

A backplane based system (e.g., the TC2K system) may implement multiple network services in the same platform (e.g., PDSN and HA functions), where each function is provided using a single network address for each function. Such an approach allows for multiple (e.g., redundant) devices, such as packet-processing cards capable of implementing PDSN and HA functions, to be associated with each network address. In such an implementation, should one device fail, another (redundant) device can nearly seamlessly take its place and continue to provide network services without any perceptible service interruption from the user's perspective.

Backplane based network platforms implementing a single-IP address approach represent an improvement over prior approaches, such as approaches that used multiple network devices (e.g., PDSN or HA devices) each with a unique IP addresses and an individual network connection. Specifically, for example, the single-IP approach allows for a reduction in the number of network connections/cables and for the use of hardware redundancy, which results in a reduced number of possible failure points and a corresponding improvement in network reliability.

2. Architecture

FIGS. 2A and 2B illustrate two different representations of a backplane-based network platform/system 200. FIG. 2A illustrates an exemplary chassis arrangement for a backplane-based network platform 200 for providing PDSN and/or HA services. The platform 200 is substantially similar to the UTStarcom TC2K wireless network platform. For purposes of this discussion, systems and methods for providing network services will be generally discussed in the context of the TC2K system (e.g., the architecture illustrated in FIGS. 2A and 2B). Of course, other system architectures are possible.

The platform 200 includes a shelf controller card 210. While the platform 200 is illustrated with a single shelf controller 210, it will be appreciated that additional shelf controller cards may be implemented in the platform 200. For example, the UTStarcom TC2K platform includes two shelf controllers. The shelf controller provides hardware management for the platform 200 and provides low-speed Ethernet connectivity (e.g., 100 Mbps) between the components of the platform 200. For example, the shelf controller recognizes when a card (e.g., packet switch or packet-processing) is inserted or removed from the platform 200 and, accordingly, applies or removes power from the respective card slots. This functionality allows for the packet-processing and packet switch cards to be “hot-swapped” (e.g., removed and replaced while the system is in operation).

The platform 200 also includes a system manager card 230. As with the shelf controller card 210, the platform 200 is illustrated with a single system manager card 230. However, additional system manager cards may be included in the platform 200, such as for redundancy purposes. The system manager card 230 is coupled with a system management bus (not shown in FIG. 2A) and provides for configuring the components of the platform 200. For example, the system manager 230 is used to establish the type of service or services the platform 200 is to provide. Using the system manager 230, the platform 200 is configured to provide HA services, PDSN services or both. In the UTStarcom TC2K platform, system management is accomplished over a 100 mbps data bus (the system management bus) using the Simple Network Management Protocol (which is described in detail in the IETF's RFC 1157), as well as UTStarcom defined proprietary communication mechanisms. RFC 1157 is incorporated by reference herein in its entirety.

The platform 200 also includes a packet switch card 220. As with the shelf controller 210 and the system manager 230, the platform 200 is shown with a single packet switch card 200 for purposes of illustration. It will be appreciated that additional, redundant packet switch cards may be included in the platform 200. The TC2K system typically includes two packet switch cards.

The packet switch card 220 operates as a distribution point for data packets in the platform 200. Packets that are received by the packet switch card 220 are then routed or forwarded to a destination (e.g., for processing or egress from the platform 200). For packets being processed in the platform 200, the packet switch card 220 will examine each packet and communicate the individual packets to a respective access gateway (AGW) card of a plurality of AGW cards 240, 245 and 250 (packet-processing devices/cards or wireless application cards) based on this examination. As indicated by the dotted lines in FIG. 2A, the platform 200 may contain additional AGW cards. The AGW card to which a particular packet is routed depends on the type of packet and/or information contained in the packet headers, such as information contained in one or more of the Layer 2 to Layer 7 headers of Internet Protocol packets.

FIG. 2B illustrates the platform 200 in a block diagram. In FIG. 2B, the platform 200 further includes a high-speed backplane 270 and a system management bus 280 (alternatively system control bus). As is shown in FIG. 2B, the packet switch card 220 and the AGW cards 240, 245 and 250 are coupled with the backplane 270. The combination of the packet switch card 220 and the high-speed backplane 270 are referred to as a Media Data Bus (MDB) in the TC2K platform. The MDB is capable of handling gigabit Ethernet communication between the packet switch card 220 and the AGW cards 240-250. Packets being processed by the platform 200 are communicated via the MDB.

In FIG. 2B, the shelf controller card 210 and the system manager card 230 are coupled with the system management bus 280 (which may also be termed a system control bus), while the management bus 280 is in turn coupled with each of the AGW cards 240-250. As was discussed above, shelf controller card 210 implements hardware management functions for the platform 200 and provides low-speed Ethernet connectivity (e.g., 100 Mbps) between the components of the platform 200. As also discussed above, the system manager 230, via the management bus 280, configures the platform 200 in accordance with the services the platform is to provide.

3. Access Gateway Card (Packet-Processing Card)

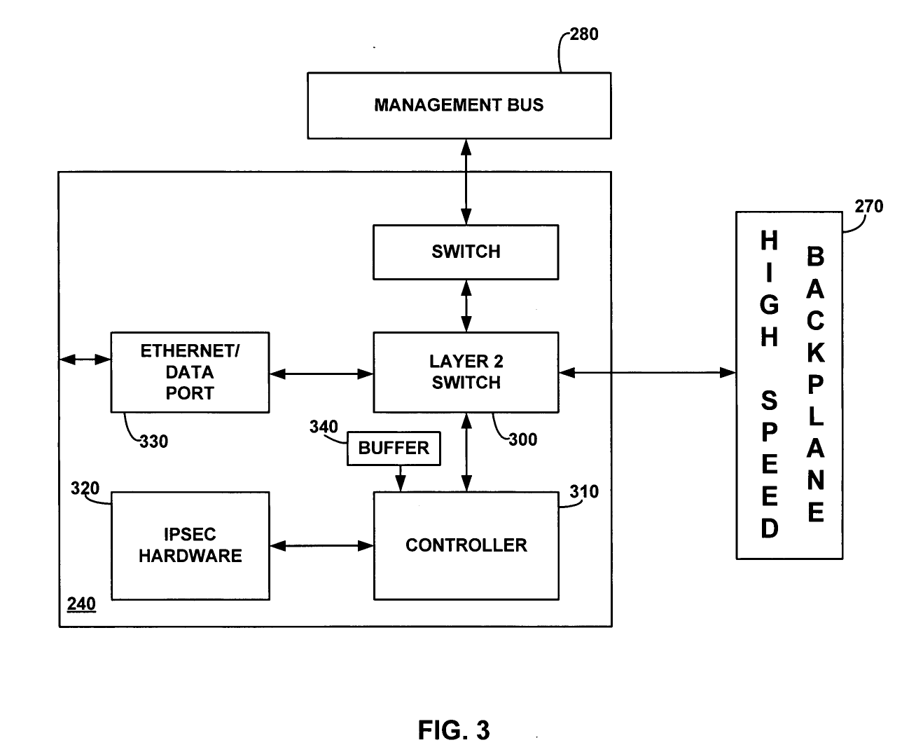

FIG. 3 illustrates the AGW Card 240 of the platform 200 in further detail. As shown in FIG. 3, the AGW card 240 is coupled with the high-speed backplane 270 and the management bus 280, as has been previously discussed. The AGW card 240 includes a Layer 2 (L2) Ethernet switch 300 that is coupled with the high-speed backplane 270. The L2 switch 300 receives packet data communicated to the AGW card 240 from the packet switch card 220 (via the backplane 270). Additionally, the L2 switch 300 communicates packet data that is being sent from the AGW card 240 to the packet switch card 220 onto the high-speed backplane 270. This communication is accomplished in accordance with any number of various data communication protocols, such as the Ethernet standard, for example. When the AGW card 240 is configured to communicate data between the network and the packet switch card, it may be said to be functioning as a NIC.

As was discussed above, processing of data packets in the platform 200 is accomplished in a distributed fashion. For example, the packet-switch 220 sends data packets to the AGW cards of the platform 200 that are dedicated to providing certain network services. For example, the packet switch 220 sends encrypted packets to the AGW cards in the platform 200 that include a decryptor and are not dedicated to performing another function such as operating as a NIC. When an encrypted packet is received at the L2 switch 300 of the AGW card 240, the L2 switch 300 communicates the packet to a controller 310 based on the header information of the encrypted packet. As an example, the packet switch card 220 modifies the Ethernet header of the encrypted packet (e.g., by inserting an MPLS header) to indicate that the AGW card 240 is the intended destination of the encrypted packet.

For clear data packets, the packet switch 220 determines the AGW card of the platform 200 that is responsible for processing the packet. For example, the packet switch 220 may examine the headers of a data packet and determine that the packet is part of a communication session (e.g., based on the source IP address of the packet) for which the platform 200 is providing PDSN services. Based on the communication session identifier (e.g., the source IP address), the packet switch card forwards the packet to the AGW card that is responsible for providing PDSN services for that particular communication session.

Once the packet is received at the AGW card 240, based on the header of the packet, the L2 switch 300 forwards the packet to the controller 310. The controller 310 then examines the packet and determines the appropriate processing that should be performed. For example, if the packet is an encrypted packet (e.g., based on the MPLS label information in the Ethernet header and/or the ESP header and sequence number), the controller 310 then forwards the encrypted packet to an IPSEC hardware device 320. The IPSEC hardware device 320 decrypts the encrypted payload of the packet using a security association (e.g., in accordance with the IPSEC protocol) indicated in an ESP header of the encrypted packet, thus producing a clear data packet. The IPSEC hardware device 320 then returns the clear data packet to the controller 310. The controller 310 modifies the MPLS header of the clear data packet to indicate that the packet switch card 220 is the destination of the clear data packet. Further, the controller 310 may also include some IPSEC related information in the modified header, such as a sequence number of the decrypted packet (e.g., in the MPLS labels that are part of the Ethernet Header). The controller 310 then sends the clear data packet to the L2 switch 300. The L2 switch 300 then communicates the clear data packet to the packet switch card 220 via the high-speed backplane 270.

If the packet is a clear data packet to be processed by the AGW card 240 (e.g., PDSN or HA processing), the L2 switch 300 examines the Ethernet header of the clear data packet and determines that the AGW card 240 is the destination. Alternatively, another AGW card in the platform 200 could receive the clear data packet for processing. The L2 switch 300 of the AGW card 240 then sends the clear data packet to the controller 310, which processes the packet (e.g., performing Point-to-Point Protocol processing, as described in the IETF's RFCs 1661, 1662 or Generic Route Encapsulation Protocol processing, such as described in the IETF's RFC 2784) to produce a processed packet. The controller 310 then sends the processed packet to the L2 switch 300 to be communicated to the packet switch 220 via the backplane 270. AGW cards that are used for providing network services (e.g., PDSN services, HA services, decryption and/or encryption) are said to be operating as NACs.

The AGW card 240 further includes an Ethernet port 330. The Ethernet port 330 may be coupled with an external network cable to allow the AGW card 240 to provide for data ingress and egress from the platform 200. In this situation, the AGW card 240 would function as a line card (NIC) and may not provide any decryption or packet processing services in the platform 200. In this situation, the L2 switch 300 effectively shunts the Ethernet port 330 with the high-speed backplane 270. As was noted above, all of the AGW cards (packet-processing cards) in the platform 200 may operate using a single-IP (network) address, with each AGW card being responsible for processing clear data packets associated with a specific, respective communication session or sessions.

The AGW card 240 additionally includes a packet buffer 340 that is coupled with the controller 310. The packet buffer 340 is used to buffer clear data packets at the AGW card 240 in the event those packets arrive at the AGW card 240 out of order. Clear data packets may arrive out of order because multiple AGW cards are used to decrypt encrypted packets that are associated with the same communication session and, depending on the loading of each of those AGW cards, may be transmitted to the AGW card 240 out of their original sequence. In the event this occurs, the buffer 340 holds the packets until a contiguous sequence of packets is present. The controller 310 then reorders the packets and processes them in sequence.

It will be appreciated that the AGW cards (e.g., the AGW card 240) of the platform 200 may operate in a number of fashions. Specifically, the AGW cards may operate as a NIC only, operate as a NAC only, or may operate as both a NIC and a NAC in the same system. Specifically, a data packet may be received from a data network by the AGW card 240. That packet is then sent to the packet switch card 220. The packet switch card 220 may then send the packet back to the AGW card 240 for PDSN or HA processing. The AGW card 240 then sends the processed packet back to the packet switch 220. The packet switch 220 may then send the packet back to the AGW card 240 for egress from the platform 200 (e.g. for communication to a destination via the network). In this situation, the AGW card 240 is operating as both a NIC and a NAC in providing network services. Such an approach for packet-processing devices may be termed as a virtual NIC/NAC implementation.

4. Packet Switch Card

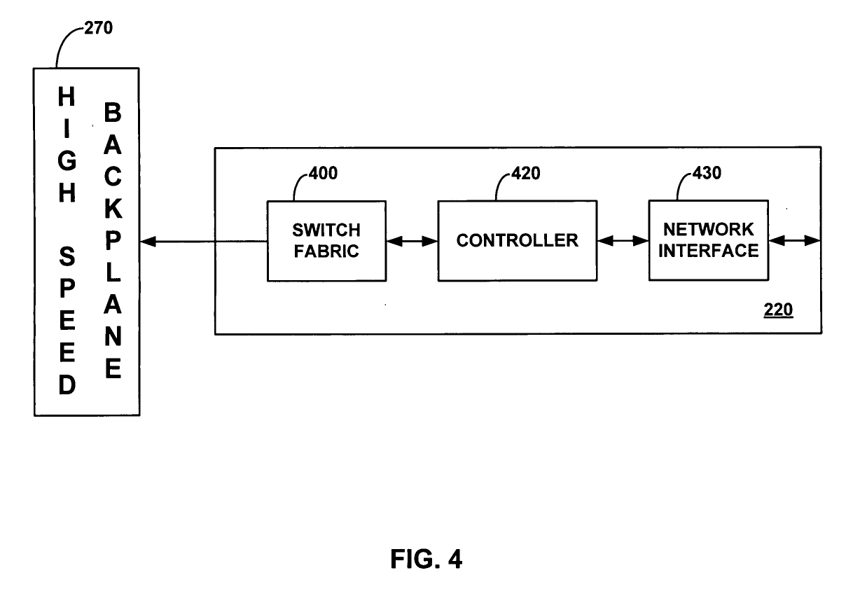

FIG. 4 illustrates the packet switch card 220 of the platform 200 in further detail. As is shown in FIG. 4, the packet switch card 220 is coupled with the high-speed backplane 270 via a switch fabric 400. As has been previously described, the packet switch card 220 communicates packet data with (to and from) the AGW cards of the platform 200 via the MDB (which includes the packet switch card 220 and the backplane 270). The switch fabric 400 may be implemented using one or more L2 switch components arranged in any suitable fashion in the packet switch card. The switch fabric 400 communicates, via the MDB, to receive and transmit packet data in the platform 200.

The packet switch card 220 further includes a programmable controller 420. The controller 420 may take the form of any appropriate instruction-processing device such as, but not limited to, a microcontroller, a microprocessor or a network processor. The controller 420 makes routing and forwarding decisions for data packets (encrypted and decrypted) received by the packet switch card 220.

The packet switch card 220 additionally includes a network interface 430 (e.g., an Ethernet port or optical data port) that may serve as a packet data ingress/egress point for the platform 200. Alternatively, data ingress/egress for the platform 200 is accomplished through one or more of the AGW cards that are operating as NICS, as was discussed above. In either situation, for the system 200, data packets entering the platform 200 are routed to the packet switch card 220. Once a data packet is received by the packet switch card 220, the packet is examined by the controller 420, which determines which AGW card of the platform 200 to route the packet to for processing.

When an encrypted data packet (an IPSEC compliant packet in this example) arrives at the packet switch card 220 (either via the network interface 430 or from an AGW card via the backplane 270), the packet headers are examined by the packet switch card 220 (e.g. by the controller 420). From this examination, the controller 420 determines that the packet is an incoming IPSEC packet based on the presence of an ESP header. The controller 420 then determines to which AGW card to send the IPSEC compliant packet. This determination is accomplished in a deterministic fashion, such as by calculating a hash function using a predetermined number of bits of the ESP header. As one example of a hash function, the modulus of the predetermined number of bits of the ESP header is determined using a prime number. Based on the result of this hash function, the controller sends the IPSEC compliant packet to an AGW card that is pre-associated with the result. Using a deterministic approach for determining which AGW card to send IPSEC compliant packets to (or any encrypted packet) is desirable. Specifically, such deterministic approaches ensure that any duplicate IPSEC packets are sent to the same AGW card, so that those duplicate packets are handled by the AGW card in accordance with the IETF's RFC 2406 requirements for handling duplicate packets.

When sending the IPSEC encrypted packet to the appropriate AGW card, the packet switch card 220 inserts a proprietary header in the packet headers to indicate that it is the source of the packet and that the respective AGW card is the destination. As was discussed above, this header may be an MPLS header or another header in accordance with any other appropriate protocol such as UDP, GRE or IP-in-IP, among numerous other protocols. After the AGW card decrypts the IPSEC compliant packet, the decrypted packet is returned to the packet switch card 220 (via the MDB) as a clear data packet.

When a clear data packet is received at the packet switch card 220 (e.g., from the network or after decryption by and AGW card), the packet switch 220 examines the clear data packet's headers (e.g. using the controller 420) to determine, for example, a communication session identifier for a communication session with which the clear data packet is associated. The controller 420 then determines which AGW card of the platform 200 is responsible for processing packets for the determined communication session. This determination may be made by consulting a table associating communication sessions that the platform 200 is servicing and the respective AGW cards responsible for those sessions. Such a table may be stored and maintained in the controller 420, for example. Alternatively, a list of the communication sessions and their associated AGW cards may be stored in a separate component in the packet switch card 220, such as in a memory device (not shown) coupled with the controller 420. It will be appreciated that other information in the clear data packet's headers may be used to determine which AGW card is responsible for processing the packet. After determining which AGW card is responsible for processing the clear data packet, the packet switch 220 forwards the clear data packet to that AGW card for processing (e.g., HA or PDSN processing) after which the AGW card responsible for the packet returns it to the packet switch card 220. Additional packet processing may then be performed in a similar fashion.

Once the processing of the packet is complete, the packet switch 220 receives a completed packet (encrypted or unencrypted). Based on an examination of the headers of the completed packet, the packet switch 220 determines that processing of the packet is complete and strips out any remaining MPLS headers and/or labels that were inserted during processing. The packet switch 220 then modifies the Ethernet header appropriately and routes the packet (processed or re-encrypted) to the destination address indicated in the headers (e.g., via the packet switch card 220's network interface or via an AGW card, depending on the particular embodiment).

Data Packet Forms During Processing

As will be appreciated from the foregoing, a data packet takes various forms during processing by the platform 200 (or in any platform implementing a distributed packet decryption technique). FIGS. 5A-5D illustrate some example packet configurations for a packet being processed by the platform 200.

FIG. 5A illustrates a clear data packet 500 in accordance with the Ethernet standard. The packet 500 is an example of a packet that is received by a platform (e.g., the HA 145) in the network 100 that is part of an unsecure communication session. The packet 500 includes an Ethernet header 501, an IP header 502 and a payload 504. After receiving the packet 500, the packet switch 220 inserts an MPLS header 512 in the packet 500 to produce the packet 510. The packet 510 is then routed to an AGW card for processing, such as in the fashion described above. The other portions of the packet 500 remain the same in the packet 510.

After the AGW card completes processing of the data packet 510, it sends a processed packet (not shown) back to the packet switch card 220 and then the packet switch card 220 strips off any remaining proprietary (e.g., MPLS in this example) headers to produce a final packet 520. The final packet 520 includes the Ethernet header 501, the IP header 502 and a processed payload 522. The final packet 530 is then routed to a destination device (or a next destination device), in accordance with the Ethernet header 501 and/or the IP header 523. Alternatively, the final packet could be re-encrypted by an AGW card of the platform 200 and sent to its next destination in encrypted form.

FIG. 5D illustrates an IPSEC encrypted packet 530, as would be received from by the platform 200 from in the data network 100 of FIG. 1, such as at the HA 145 from the private network 150. The packet 530 is also representative of a completed encrypted packet that is communicated to a destination by the platform 200 after processing. The encrypted packet 530 includes an Ethernet header 531 and an outer IP header 532, which indicate the source of the packet and the destination of the encrypted packet (in this case, the platform 200, at least as an intermediate destination). The encrypted packet 530 also includes an IPSEC compliant ESP header 534 (which contains a sequence number) an encrypted payload 536 and an ESP trailer 538, in accordance with the IPSEC protocol. The packet switch 220 then inserts an MPLS header in the packet 530 and routes the encrypted packet to an AGW card for decryption, such as in the fashion described above. After decryption, the AGW card to which the packet was sent to for decryption returns a clear data packet in substantially this same form as the packet 510 discussed above. The platform 200 then proceeds to perform any additional network services (e.g., PDSN or HA services) on the packet before communicating a final version of the packet to its destination.

Method for Processing Encrypted Data Packets

FIG. 6 illustrates a method 600 for providing network services, such as encryption, decryption, PDSN and/or HA services, as some examples. The method 600 may be implemented in the platform 200 using the techniques described above. The method 600 includes, at block 610, receiving a data packet at a packet switch card. The data packet is received via a first packet-processing card (e.g., an AGW card operating as a NIC) and a high speed bus in a network platform including both the packet switch card and the first packet processing card (e.g., a TC2K platform).

At block 615, the method 600 includes determining a second packet-processing card for processing the packet. In the case of an encrypted packet, a hash function may be used in the manner discussed above. The encrypted packet is then forwarded to the second packet-processing card at block 620 and is decrypted by the second packet-processing device at block 625 to produce a clear data packet. In the case of a clear data packet, the packet switch determines the communication session with which the packet is associated at block 615 and communicates the packet to the AGW card responsible for providing network services for that communication session at block 620.

After processing (e.g., decrypting or performing PDSN or HA services) the second packet-processing card communicates the data packet back to the packet switch card at block 630. At block 635, the packet switch card then determines if additional processing is to be performed, such as performing PDSN or HA services on a packet that was originally encrypted, or encrypting a packet that was originally a clear packet. If additional services are to be provided, the packet switch determines a third packet processing card for processing the packet (e.g., performing PDSN or HA services or encrypting the packet) in the manner described above, and communicates the data packet to the third packet-processing card at block 640. In this instance, the AGW card is behaving as a NAC. The third packet-processing card then processes the packet (e.g., performs HA services, PDSN services or encryption) at block 645 to produce a processed packet.

At block 650, the third packet-processing device communicates the processed packet back to the packet switch. At block 655, the packet switch communicates the processed packet to a destination device via the first packet-processing device.

### CONCLUSION

Various arrangements and embodiments have been described herein. It will be appreciated, however, that those skilled in the art will understand that changes and modifications may be made to these arrangements and embodiments without departing from the true scope and spirit of the present invention, which is defined by the following claims.

What is claimed is:

1. A platform for processing data packets included in a flow of packet data traffic being communicated in a data network, the platform comprising:
a backplane for routing the data packets within the platform;
a packet switch card coupled with the backplane, the packet switch card aggregating the flow of packet data traffic in the platform; and
a plurality of application cards coupled with the backplane, each of the application cards of the plurality selectively operating as at least one of a network interface card and a network access card,
wherein at least a first application card of the plurality operates as a network interface card, the first application card communicating at least a portion of the flow of packet data traffic from the network to the packet switch card.

2. The platform of claim 1, wherein each application card of the plurality of application cards includes service logic to provide:
packet data serving node functions; and
home agent functions.

3. The platform of claim 1, wherein each of the application cards includes:
a data port coupled with the data network;
a data switch coupled with the data port and the backplane; and
a controller coupled with the data switch,
wherein the data switch selectively routes the data packets to and from:
the data port and the backplane;
the controller and the high-speed back plane; and
the data port and the controller.

4. The platform of claim 3, wherein the data port comprises an Ethernet data port.

5. The platform of claim 3, wherein the data switch comprises a Layer 2 Ethernet Protocol switch.

6. The platform of claim 3, wherein the controller comprises a microprocessor.

7. The platform of claim 3, further comprising a system management bus coupled with the data switch, wherein the data switch selectively routes system management data to and from the controller.

8. The platform of claim 1, wherein the packet switch card comprises:
a data port coupled with the backplane;
a data switch coupled with the backplane; and
a programmable controller coupled with the data switch.

9. The platform of claim 8, wherein the data switch comprises a level 2 Ethernet Protocol switch.

10. The platform of claim 8, wherein the packet data switch comprises a plurality of interconnected level 2 Ethernet Protocol switches.

11. The platform of claim 8, wherein the programmable controller comprises a microprocessor.

12. The platform of claim 8, wherein the programmable controller comprises a network processor.

13. In a platform for processing data packets in a data network, the platform comprising a backplane, a plurality of packet-processing devices coupled with the backplane and a packet switch card coupled with the backplane, a method of processing data packets comprising:
receiving a data packet from the data network at a first packet processing device of the plurality of packet-processing devices;
communicating the data packet from the first packet-processing device to the packet switch card via the backplane;
with the packet switch card, determining a second packet-processing device for processing the data packet;
communicating the data packet from the packet switch to the second packet-processing devices via the backplane;
executing service logic on the second packet-processing device to produced a processed packet from the data packet; and
communicating the processed packet from the second packet-processing device back to the packet switch card via the backplane.

14. The method of claim 13, further comprising:
communicating the processed packet from the packet switch card to the first packet-processing device; and
communicating the processed packet from the first packet-processing device to a destination network address via the network.

15. The method of claim 13, further comprising:
communicating the processed packet from the packet switch card to a third packet-processing device; and
communicating the processed packet from the third packet-processing switch to a network destination address via the network.

16. The method of claim 13, wherein executing service logic on the second packet-processing device comprises performing home agent services on the data packet.

17. The method of claim 13, wherein executing service logic on the second packet-processing device comprises performing packet data serving node services on the data packet.

18. The method of claim 13, further comprising:
with the packet switch card, determining a third packet-processing device for further processing the processed packet; and
communicating the processed packet from the packet switch card to the third packet-processing device via the backplane;
executing service logic on the third packet-processing device to further process the processed packet to produce a further-processed packet; and
communicating the further-processed packet back to the packet switch card.

19. The method of claim 18, further comprising:
communicating the further-processed packet from the packet switch card to the first packet-processing device; and
communicating the further-processed packet from the first packet-processing device to a destination network address via the network.

20. The method of claim 18, further comprising:
communicating the further-processed packet from the packet switch card to a third packet-processing device; and
communicating the further-processed packet from the third packet-processing switch to a network destination address via the network.

21. The method of claim 18, wherein executing service logic to process the data packet comprises performing one of home agent services and packet data serving node services.

22. The method of claim 21, wherein executing service logic to further process the processed packet comprises performing one of encryption or virtual private network services.

23. The method of claim 18, wherein executing service logic to process the data packet comprises decrypting the data packet.

24. The method of claim 23, wherein executing service logic to further process the processed packet comprises performing one of home agent services and packet data serving node services.

25. A network platform for processing data packets comprising:
is a plurality of packet-processing devices;
a packet switch card operationally coupled with the plurality of packet-processing devices; and
a backplane for communicating data packets between the packet switch and the plurality of packet-processing devices;
wherein the packet switch card and the plurality of packet-processing devices include machine executable instructions that, when executed, collectively provide for:
receiving a data packet from the data network at a first packet processing device of the plurality of packet-processing devices;
communicating the data packet from the first packet-processing device to the packet switch card via the backplane;
with the packet switch card, determining a second packet-processing device for processing the data packet;
communicating the data packet from the packet switch to the second packet-processing devices via the backplane;
executing service logic on the second-packet-processing device to produced a processed packet from the data packet; and
communicating the processed packet from the second packet-processing device back to the packet switch card via the backplane.

26. The network platform of claim 25, wherein the instructions, when executed, further provide for:
communicating the processed packet from the packet switch to the first packet-processing device; and
communicating the processed packet from the first packet-processing device to a destination address via the network.

27. The network platform of claim 25, wherein the instructions, when executed, further provide for:
communicating the processed packet from the packet switch to a third packet-processing device; and
communicating the processed packet from the third packet-processing device to a destination address via the network.

28. The network platform of claim 25, wherein the instructions, when executed, further provide for:
with the packet switch card, determining a third packet-processing device for further processing the processed packet; and
communicating the processed packet from the packet switch to the third packet-processing device via the backplane;
executing service logic on the third packet-processing device to further process the processed packet to produce a further-processed packet; and
communicating the further-processed packet from the third packet-processing device back to the packet switch card.
